(19) United States
(12) Patent Application Publication
(10) Pub. No.: US 2010/0071820 A1
(43) Pub. Date: Mar. 25, 2010

(54) Tire and noise reducer

(75) Inventors: Gary C. Noggle, Norton, OH (US); James F. Siegfried, Medina, OH (US)

Correspondence Address: BRIDGESTONE AMERICAS, INC., 1200 FIRESTONE PARKWAY, AKRON, OH, 44317, US

(73) Assignee: BRIDGESTONE AMERICAS TIRE OPERATIONS, LLC, NASHVILLE, TN (US)

(21) Appl. No.: 12/546,172

(22) Filed: Aug. 24, 2009

Related U.S. Application Data
(60) Provisional application No. 61/099,588, filed on Sep. 24, 2008.

(51) Int. Cl. B60C 19/00

(52) U.S. Cl. 152/341.1; 152/331.1

(57) ABSTRACT

A tire is disclosed comprising a tread portion, two sidewall portions, two bead portions, an internal surface of the tire that forms a tire cavity, and at least three baffles within the tire cavity. The baffles may be made of compressible or non-compressible materials and may further include connecting members, encapsulating liners, or both. Further, a tire kit is disclosed comprising at least three baffles and at least one connecting member that connects the baffles. In addition, a method is disclosed that includes filling a tire with at least three baffles and then assembling the tire on a tire rim to reduce tire noise or to reduce tire force transmissibility.

### CROSS-REFERENCE TO RELATED APPLICATIONS

This U.S. non-provisional application claims priority from U.S. Provisional Patent Application No. 61/099,588, inventors Noggle et al., entitled TIRE NOISE AND FORCE REDUCER, filed Sep. 24, 2008, the disclosure of which is incorporated by reference herein in its entirety.

### FIELD OF INVENTION

The present application relates to tires and, more particularly, to a tire with internal baffles to reduce tire noise, to reduce tire force transmissibility, or both.

### BACKGROUND

As cars and trucks become quieter, customers have increased pressure on tire manufacturers to reduce tire noise. Tire noise includes sounds generated from external and internal tire attributes. A tread pattern is an example of an external tire attribute that can add to tire noise. An example of an internal tire attribute that can add to tire noise is the tire's cavity. Acoustic cavity resonance is a type of tire noise formed within a tire cavity or an air chamber of the tire. The reduction of this internal acoustic cavity resonance noise is desirable to provide a quieter tire.

### SUMMARY

A tire is disclosed comprising a tread portion, two sidewall portions, two bead portions, an internal surface of the tire that forms a tire cavity, and at least three baffles within the tire cavity. The baffles may be made of compressible or non-compressible materials and may further include connecting members, encapsulating liners, or both. Further, a tire kit is disclosed comprising at least three baffles and at least one connecting member that connects the baffles. In addition, a method is disclosed that includes filling a tire with at least three baffles and then assembling the tire on a tire rim to reduce tire noise or to reduce tire force transmissibility.

### BRIEF DESCRIPTION OF THE DRAWINGS

In the accompanying drawings, embodiments of a tire, a tire kit, and a method to reduce tire noise or tire force transmissibility are illustrated that, together with the detailed description provided below, describe exemplary embodiments of the tire, the tire kit, and the method. One of ordinary skill in the art will appreciate that the illustrated boundaries of elements in the drawings represent one example of the boundaries. Further, one element or step may be designed as multiple elements or steps or multiple elements or steps may be designed as a single element or step. An element shown as an internal component of another element may be implemented as an external componentand vice-versa.

Further, in the accompanying drawings and description that follow, like parts are indicated throughout the drawings and description with the same reference numerals, respectively. The figures are not drawn to scale and the proportions of certain parts have been exaggerated for convenience of illustration.

FIG. 1 illustrates a side view of a tire 100, showing internal locations of baffles and connecting members as hidden lines;

FIG. 2 illustrates a side view of another embodiment of a tire 200, showing internal locations of baffles and connecting members as hidden lines;

FIG. 3 is a cross-section of the tire 100, along line A-A of FIG. 1;

FIG. 4 illustrates a cross-section of another embodiment of a tire 300 that has a different cross-section than the cross-section of FIG. 3;

FIG. 5 illustrates a cross-section of another embodiment of a tire 400 that has a different cross-section than the cross-section of FIG. 3;

FIG. 6 illustrates a graph of ARC interior noise;

FIG. 7 illustrates a graph of force transmissibility; and

FIG. 8 illustrates a flow chart of a method to reduce tire noise and tire force transmissibility 800.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Bead” refers to the part of the tire that contacts the wheel and defines a boundary of the sidewall.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Lateral” refers to a direction along the tread of the tire going from one sidewall of a tire to the other sidewall.

“Radial” and “radially” refer to a direction perpendicular to the axis of rotation of a tire.

“Sidewall” refers to that portion of the tire between the tread and the bead.

“Tread” refers to that portion of the tire that comes into contact with the road under normal inflation and load.

A tire assembled on a rim has internal acoustic characteristics that are similar to a drum or a guitar. The tire's inner cavity amplifies sound waves that originate from various impacts on the outer surface of the tire in the same way a drum or a guitar amplifies sound waves produced from impacts that originate on their outer surfaces. As the tire rotates, lugs and other tire features on the tire's outer circumferential surface impact the road surface and produce a tire cavity sound wave with a frequency that is amplified by the internal surface of the tire as the sound wave reflects and propagates through the cavity of the tire.

Amplification of internal tire sound waves produces sounds similar to those transmitted in a pipe of a musical organ. The musical organ pipe has a diameter and a length that produce a single sound wave. Similarly, the tire has a diameter and a circumferential length that keep sound waves inside a tire to about one wavelength.

Tire noise can be heard inside and outside a moving automobile. Original equipment manufacturers give tire manufacturers tire noise limits and test parameters used to measure tire noise. Tire manufacturers in turn test the tires according to these parameters and measure the amount of noise produced by the tires, along with other tire characteristics, e.g., force transmissibility or tire force measured at a rotational axis of an assembled tire. Tire manufacturers continuously search for techniques that they can implement to reduce tire cavity sounds and to reduce the amount of force a tire applies to an axis of an assembled tire and rim assembly.

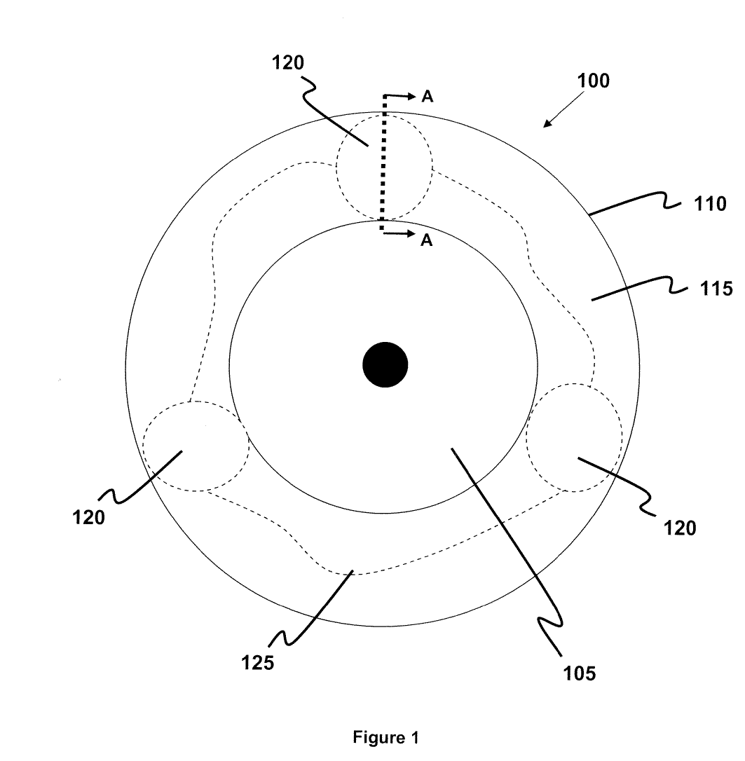

The inventors of the claimed invention discovered a tire, a tire kit, and a method to reduce tire noise and to reduce tire force transmissibility. In general, the claimed tire has a plurality of baffles that reduce tire noise and that reduce force transferred from the tire to the axis of rotation of a tire and rim assembly. During assembly of a tire and rim, a tire technician inserts the baffles inside the tire cavity in at least three locations. FIG. 1 illustrates a side view of a tire 100 mounted on a rim 105 (internal components shown as hidden lines). In the illustrated embodiment, the tire 100 includes a tread portion 110, two sidewall portions 115, at least three baffles 120 inside the cavity of the tire 100, and connecting members 125.

In the illustrated embodiment of FIG. 1, the baffles 120 are preferably made from a durable, flexible (compressible) rubber material. Alternatively, the baffles 120 are made from latex or Mylar. In still other embodiments, the baffles 120 can be made from a light, non-inflatable material that maintains its shape (non-compressible) under inflated tire pressure. These materials include but are not limited to foam, plastic, textile materials, or the like.

Further in the illustrated embodiment of FIG. 1, the baffles 120 are self supporting and are about equally spaced around the circumference of the tire 100. The baffles 120 are self supporting because the shape of each baffle 120 provides an interference fit with at least one portion of the internal surface of the tire 100. In the illustrated embodiment, circumferentially equal spacing between the baffles 120 is maintained by attaching ends of each connecting member 125 onto two different baffles 120.

In other embodiments (not shown), the baffles 120 are not about equally spaced around the circumference of the tire 100. If the baffles are not about equally spaced, then more than three baffles 120 will be required to produce similar reduction of tire sound and tire force transmissibility. In yet other embodiments (not shown), the connecting members 125 are not included but rather an interference fit of each baffle 120 with the internal surface of the tire 100 provides enough force to keep the baffle 120 in place as the tire 100 is assembled to the rim 105 and as the tire 100 rotates during use.

In the illustrated embodiment of FIG. 1, the connecting members 125 are made from a plastic wire. In other embodiments (not shown), the connecting members 125 are made from latex, cloth, rubber, or similar connecting material. In yet other embodiments (not shown), the connecting members 125 are made from metal wire, e.g., aluminum wire, copper wire, titanium wire, and the like. In a preferred embodiment, the weight of the connecting members is insignificant, such that they do not offset the balance of the tire.

In the illustrated embodiment of FIG. 1, the baffle 120 has a circular cross section, laterally across the tire. In other embodiments (not shown), the baffle 120 has a cross section, laterally across the tire, of a different geometry, such as without limitation an oval, square, rectangle, triangle, rounded rectangle, pentagon, hexagon, or octagon.

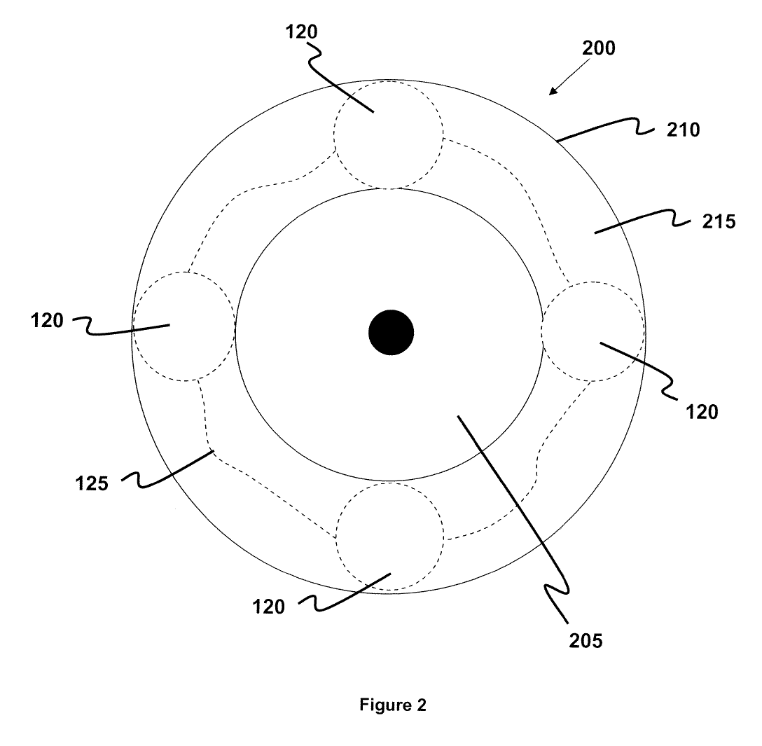

FIG. 2 is an alternative embodiment of a tire 200 according to the claimed invention (internal components shown as hidden lines). Tire 200 is substantially identical to tire 100, except that tire 200 includes an additional baffle 120 and connecting member 125 inside the cavity of tire 200. In yet other embodiments (not shown), the tire according to the claimed invention includes more than four baffles inside the cavity of the tire.

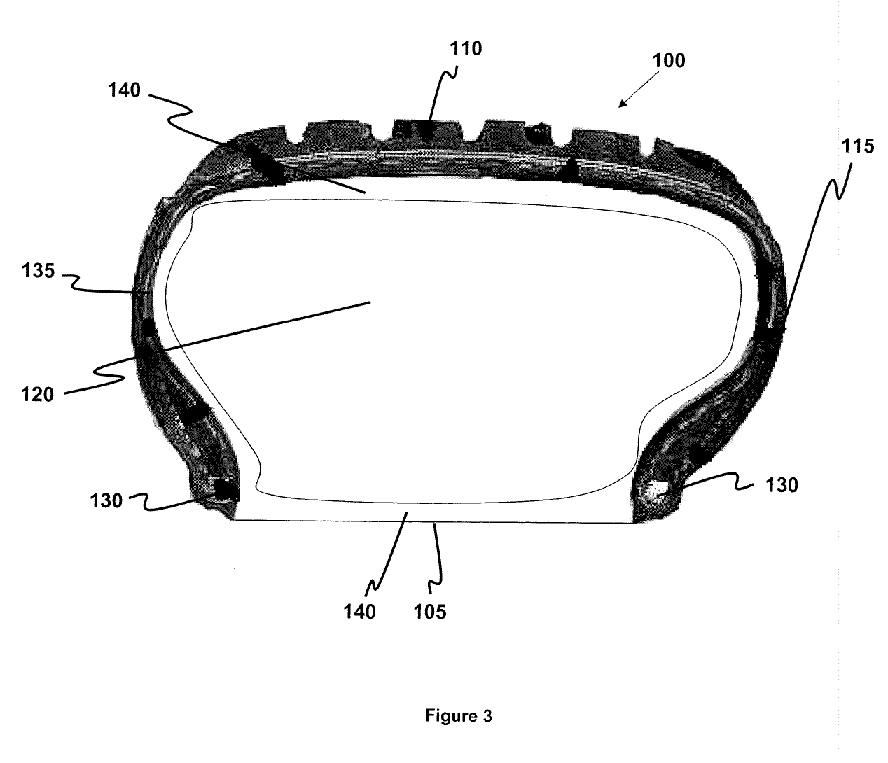

FIG. 3 is a cross-section of the tire 100 and the baffle 120, along line A-A of FIG. 1. In the illustrated embodiment, the tire 100 includes two bead portions 130 and a tire liner 135. A perimeter created by the rim 105 and the tire liner 135 forms a tire cavity 140 that surrounds the rim. In the illustrated embodiment, the baffle 120 has a shape that conforms to the tire cavity 140. In yet other embodiments (not shown), the tire cavity contains more than one baffle in the cross section of the tire.

In use, baffles 120 are pressurized with air. The pressurized air in the baffles 120 is at a pressure that counteracts the recommended operating air pressure of tire 100, such that the baffles 120 maintain their shape when the tire 100 is pressurized. Alternatively, the baffles 120 are filled with at least one of the following gases: nitrogen, helium, and other inert gases.

In other embodiments (not shown), the baffles 120 may have an adhesive (not shown) on a radially outer surface that, when pressed against tire liner 135, baffles 120 are held in place. The adhesive (not shown) is made of material that includes at least one of the following: double sided adhesive tapes, spray on adhesives, glues, and the like.

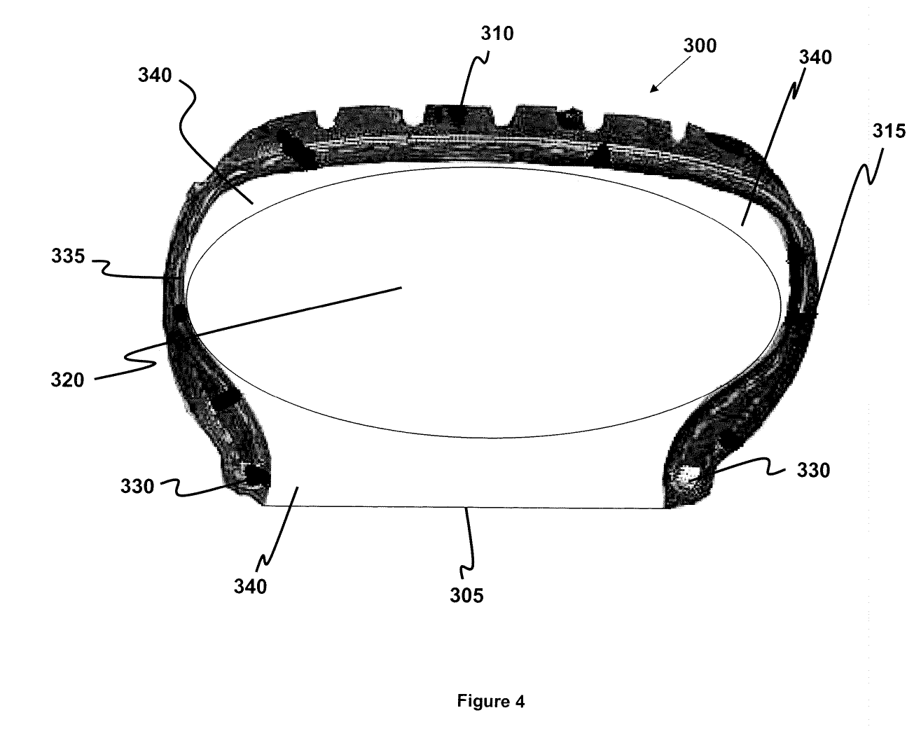

FIG. 4 illustrates a cross-section of another embodiment of a tire 300 that has a different cross-section than the cross section of FIG. 3. Tire 300 is substantially identical to tire 100 except that tire 300 includes a different shaped baffle 320. In the illustrated embodiment, the baffle 320 has an elliptical shape that substantially conforms to the tire cavity 340, so the baffle 320 fills at least about 75% of the cross sectional area of the tire cavity 340. In another embodiment (not shown), the baffle 320 fills between about 50% to 100% of the cross sectional area of the tire cavity 340. Preferably, the baffle 320 fills between about 75% and 100% of the cross sectional area of the tire cavity 340. More preferably, the baffle 320 fills between about 85% and 100% of the cross sectional area of the tire cavity 340. Most preferably, the baffle 320 fills between about 95% and 100% of the cross sectional area of the tire cavity 340.

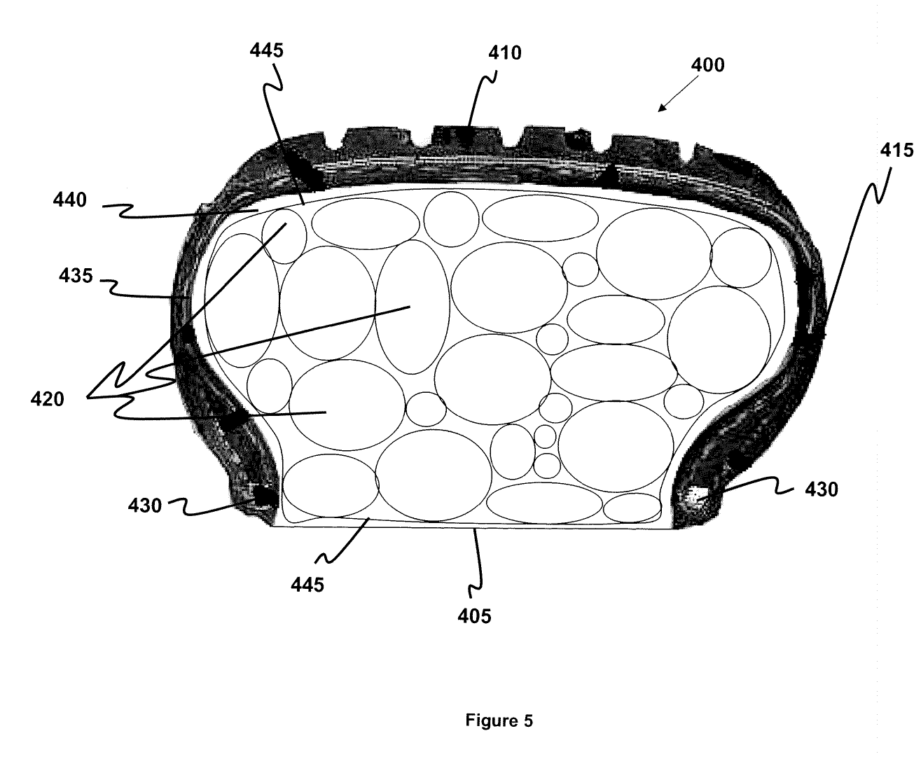

FIG. 5 is yet another embodiment of a tire according to the claimed invention, tire 400. The cross section of tire 400 is similar to the tires of previous figures. However, there are multiple baffles 420 shown in cross section and they have various cross-sectional shapes and sizes. Further, the multiple baffles 420 are enclosed with an encapsulating liner 445 in at least three locations; the encapsulating liner 445 insures that the multiple baffles 420 stay together during use of the tire 400 and serves as a protective layer. The connecting members (not shown) insure that the multiple baffles 420 stay about equally spaced around the circumference of the tire 400. In other embodiments (not shown), the baffles 420 are the same shape and size. In yet other embodiments (not shown), the baffles 420 can increase or decrease in number. In other embodiments (not shown), the encapsulating liner 445 stays in a circumferential location within the tire cavity 440 by an interference fit with the tire liner 435 and the rim 405 and is further assisted by the connecting members (not shown). The encapsulating liner 445 is made from at least one of the following materials: rubber, plastic, latex, and textiles.

In the illustrated embodiment, the encapsulating liner 445, the baffles 420, and the connecting members (not shown) are configured so they do not interfere with the tire 400 or the rim 405 during assembly. The baffle 420 must stay radially outside the rim 405 and inside the tire cavity 440. For example, the connecting members (not shown) are designed so they do not move radially inward towards the rim 405. Further, the encapsulating liner 445 is axially larger than the distance between the two bead portions 430 so the encapsulating liner 445 can not shift radially inward and interfere with assembly of the tire 400 and the rim 405.

In another embodiment (not shown), the baffles 120, 320, 420 and the connecting members 125 form a tire kit that can be installed into a tire and rim assembly. The baffles of the tire kit have cross sections that are substantially similar to a cross section of a conventional tire cavity. Further, the baffles 120, 320, 420 may include an adhesive on their outer surfaces so the baffles 120, 320, 420 can be attached to the internal surface of the tire. In yet other embodiments (not shown), the tire kit includes at least one encapsulating liner.

The inventors of the claimed invention monitored tire noise reduction associated with tires incorporating baffles. During testing, the inventors measured a 1.5 dB reduction in noise when the cross section of the tire cavity 140 was 25% filled with three baffles 120 that were about equally spaced around the circumference of the tire, relative to an empty tire cavity 140. In addition, the inventors measured a 4.0 dB reduction in noise when the cross section of the tire cavity 140 was 50% filled with three baffles 120 that were about equally spaced around the circumference of the tire, measured a 7.0 dB reduction in noise when the cross section of the tire cavity 140 was 75% filled with three baffles 120 that were about equally spaced around the circumference of the tire, and measured an 8.0 dB reduction in noise when the cross section of the tire cavity 140 was 100% filled with three baffles 120 that were about equally spaced around the circumference of the tire.

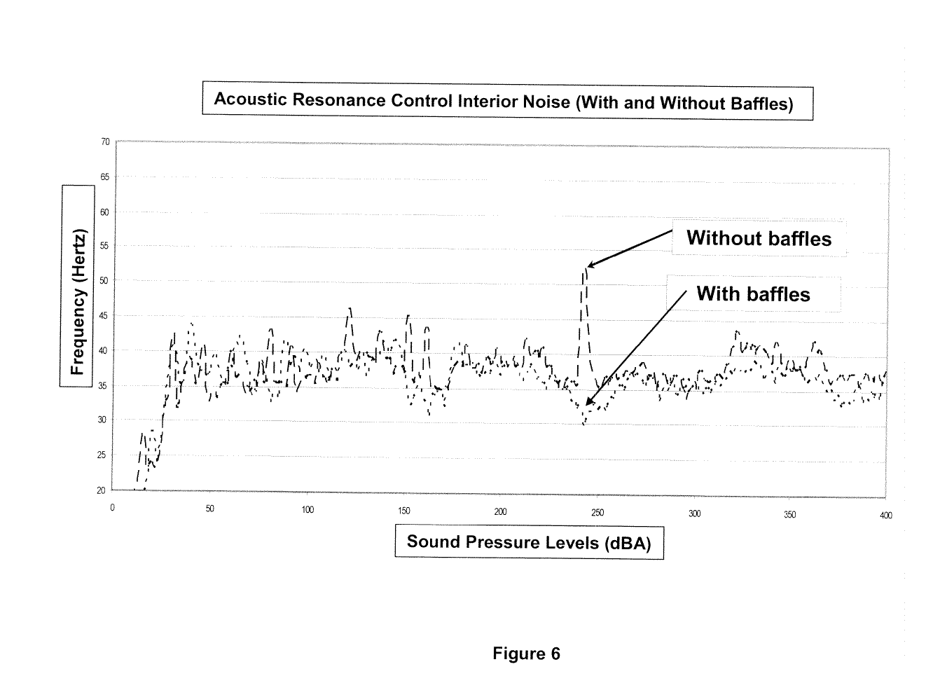

FIG. 6 illustrates an acoustic resonance control (“ARC”) graph of interior noise for a tire 100 with the baffles, illustrated in FIG. 1, compared to the same tire without the baffles on a controlled stretch of road. The data graphed in FIG. 6 was gathered on a road test where a Bruel & Kjaer microphone, model 4165, is mounted in a car location where a front passenger's left ear would be. The microphone connects to a Sony digital recorder that converts analog sound waves (sound pressure) to a digital recording of the sound waves. The digital recorder measures sound wave amplitudes as a function of time. The digital recordings of the sound waves (pressure) with the baffles and without the baffles were played back into a spectrum analyzer to convert the time dependent data to frequency dependent data, sound wave amplitude as a function of frequency. The spectrum analyzer produces a graph of the frequency dependent data that tire designers compare and contrast to make tire design decisions.

The natural frequency ω of a cavity is defined by the mathematical expression of ω=c/L, where c is the speed of sound in air and L is the cavity length. For a tire, the natural frequency ω is the speed of sound in air c divided by the tire cavity length L. The range of the natural frequencies ω for passenger and truck tires is typically between 200-250 Hertz. In the graph illustrated in FIG. 6 between 200 and 250 dBA, about a 23 Hz difference in frequency appears between the plots of the tire with the baffle apparatus and the tire without the baffle apparatus. Specifically on the graph at 240 dBA, the tire with the baffle apparatus generates a tire noise frequency of about 30 Hz and the tire without the baffle apparatus has a tire noise frequency of about 53 Hz.

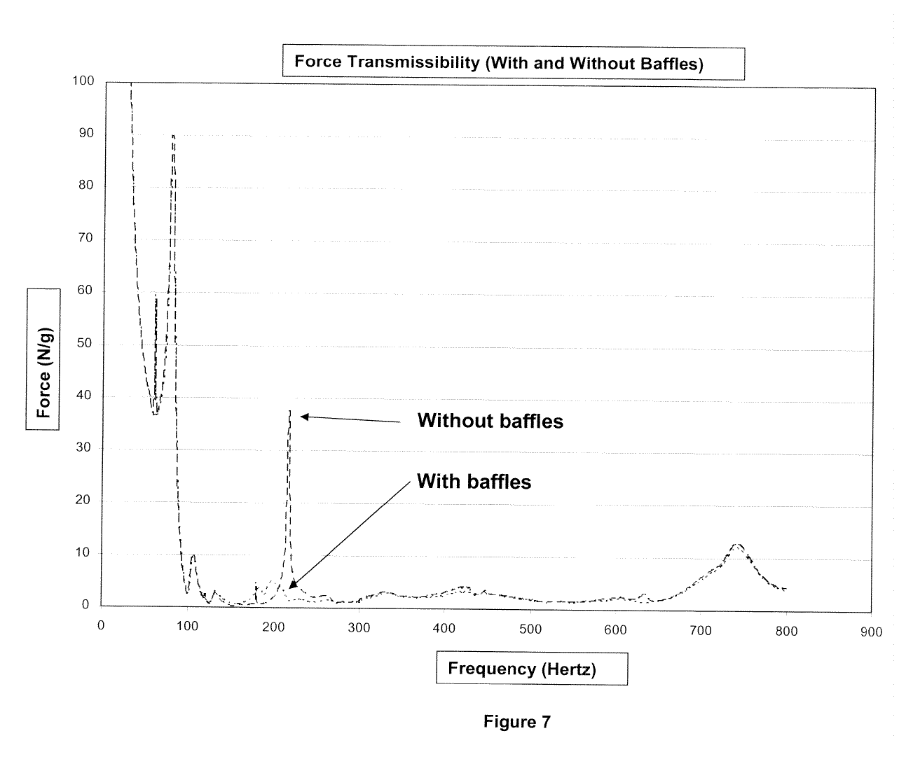

FIG. 7 illustrates a force transmissibility graph for a tire 100 with the baffle apparatus, illustrated in FIG. 1, compared to the same tire without the baffle apparatus. The inventors gathered the data graphed in FIG. 7 during a non-rotating laboratory test. In the non-rotating laboratory test, the tire 100 mounts to a test fixture and then the tire 100 is loaded with a hydraulic actuator that applies a static load and a vibration. The hydraulic actuator includes an accelerometer that measures input vibration acceleration (measured in number of g's where 1 g is equal to 9.8 m/s² or acceleration due to gravity). The transmitted load variation (measured in Newton's, N) produced by the hydraulic actuator is measured by a load sensor located on the test fixture's axle. A tire designer can graph these measurements to get a frequency response function of the axle force/acceleration measured in N/g's.

The graph shows the force transmissibility or force transferred to the axis of the tire testing machine as a function of sound frequency between a tire 100 with a baffle apparatus and the same tire 100 without the baffle apparatus. In the graph between 200 and 250 Hz, about a 33 N/g difference in force transmissibility appears between the plots of the tire with the baffle apparatus and the tire without the baffle apparatus. At about 215 dBA, the tire with the baffle apparatus has about 5 N/g transmissibility and the tire without the baffle apparatus has about 38 N/g transmissibility.

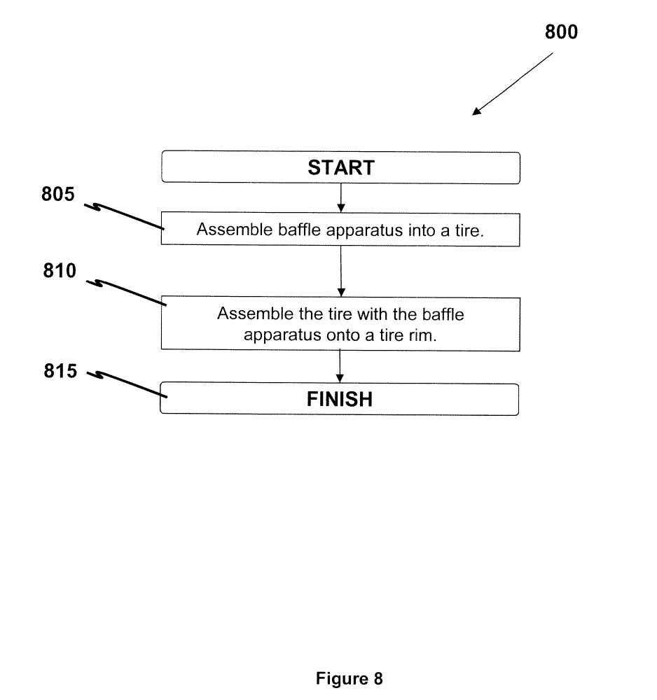

FIG. 8 illustrates steps of a method to reduce tire noise and tire force transmissibility 800. In FIG. 8, a technician assembles a baffle apparatus into a tire in at least three locations at step 805. The technician then assembles the tire with the baffle apparatus onto a tire rim at step 810, and then the method is finished at 815. In other embodiments of the method (not shown), the method further includes the step of adhering the baffle apparatus to an internal surface of a tire. In yet another embodiment of the method (not shown), the baffle apparatus is assembled into a tire to fill or block at least 50% of a tire cavity, preferably about 75% to 100%, more preferably about 85% to 100%, or most preferably about 95% to 100% of the tire cavity.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application illustrates various embodiments, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A tire comprising:
a tread portion;
two sidewall portions;
two bead portions;
a tire liner;
an internal surface of the tire that forms a tire cavity; and
at least three baffles inside the tire cavity.

2. The tire of claim 1, wherein the at least three baffles are made from at least one of the following materials: latex, Mylar, rubber, foam, plastic, and textile.

3. The tire of claim 3, wherein the at least three baffles are pressurized with at least one of the following: air, nitrogen, helium, and other inert gases.

4. The tire of claim 1, wherein the at least three baffles are made from a compressible material.

5. The tire of claim 1, wherein the at least three baffles form interference fits with at least one portion of the internal surface of the tire.

6. The tire of claim 5, wherein cross sections of the at least three baffles each fill at least 50% of a cross section of the tire cavity.

7. The tire of claim 5, wherein each of the at least three baffles have cross sections of one of the following shapes: a circle, an oval, a square, a rectangle, a triangle, a rounded rectangle, and a pentagon.

8. The tire of claim 1, wherein each of the at least three baffles are about equally spaced circumferentially inside the tire cavity.

9. The tire of claim 1, wherein outer surfaces of the at least three baffles further include an adhesive.

10. The tire of claim 9, wherein the adhesive on the outer surfaces of each of the at least three baffles include at least one of the following: double sided adhesive tape, spray on adhesive, and glue.

11. The tire of claim 1, wherein the tire further includes at least one encapsulating liner that encapsulates the at least three baffles.

12. The tire of claim 1, wherein the tire further includes at least one connecting member that connects the baffles to each other.

13. The tire of claim 12, wherein the at least one connecting member is made from one of the following materials: rubber, plastic, textiles, copper, aluminum, and titanium.

14. A tire kit for use with a tire, the kit comprising:
at least three baffles; and
at least one connecting member that connects the baffles.

15. The kit of claim 14 further comprising at least one encapsulating liner.

16. The kit of claim 14, wherein each of the at least three baffles have a cross section that is substantially similar to the cross section of a conventional tire cavity.

17. The kit of claim 14 wherein the outer surface of each of the at least three baffles further includes an adhesive.

18. A method for reducing tire noise or tire force transmissibility, the method comprising:
filling a tire with at least three baffles; and
assembling the tire on a tire rim.

19. The method of claim 18, the method further comprising adhering outer surfaces of each of the at least three baffles to an internal surface of the tire.

20. The method of claim 18, the method further comprising filling the tire with at least three baffles so a cross section of the tire is at least 50% filled with the at least three baffles in at least three circumferential locations.
